(19) United States
(12) Patent Application Publication
(10) Pub. No.: US 2022/0270051 A1
(43) Pub. Date: Aug. 25, 2022

(54) BENEFIT NOTIFICATION SYSTEM AND METHOD FOR USE THEREWITH

(71) Applicant: Enrollease, Inc., San Francisco, CA (US)

(72) Inventors: Courtney Guertin, San Francisco, CA (US); David Reid, Las Vegas, NV (US)

(73) Assignee: Enrollease, Inc., San Francisco, CA (US)

(21) Appl. No.: 17/179,923

(22) Filed: Feb. 19, 2021

(51) Int. Cl. G06Q 10/10; H04L 12/58

(52) U.S. Cl. CPC G06Q 10/1057; H04L 51/24

(57) ABSTRACT

A benefit notification system operates by: generating an interactive interface for display via a display device, wherein the interactive interface displays default benefit notification data corresponding to a particular company, notification types and a default subset of notification recipient types for each of the notification types, wherein each of the notification types has a corresponding condition of a set of conditions; storing, in response to a user interaction via the interactive interface, updated benefit notification data, wherein the updated benefit notification data includes a selected subset of the notification recipient types for each of the notification types; obtaining employee benefit records associated with employees of the company; comparing the employee benefit records to the conditions; automatically generating a benefit notification for one of the notification types when the employee benefit records match the corresponding condition; and facilitating transmission, based on the updated benefit notification data, of the benefit notification to notification recipients corresponding to the selected subset of the notification recipient types corresponding to the particular notification type.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND

### Technical Field

This invention relates generally to automated administrative processing systems used in conjunction with client/server and other network architectures for managing employee benefits and other human resource functions.

### Description of Related Art

### BRIEF DESCRIPTION OF THE SEVERAL VIEWS OF THE DRAWING(S)

FIG. 1 is a schematic block diagram of an embodiment of an admin processing system;

FIG. 2A is a schematic block diagram of a client device in accordance with various embodiments;

FIG. 2B is a schematic block diagram of one or more admin subsystems in accordance with various embodiments;

FIG. 3A is a schematic block diagram of a benefit notification system in accordance with various embodiments;

FIG. 3B is a schematic block diagram of a benefit notification system in accordance with various embodiments;

FIG. 3C presents a table of notification types, conditions and notification recipient types in accordance with various embodiments;

FIGS. 4A-4I are screen displays of an interactive interface in accordance with various embodiments; and

FIG. 5 is a flowchart representation of a method in accordance with various embodiments.

### DETAILED DESCRIPTION

One or more embodiments are now described with reference to the drawings, wherein like reference numerals are used to refer to like elements throughout. In the following description, for purposes of explanation, numerous details are set forth in order to provide a thorough understanding of the various embodiments. It is evident, however, that the various embodiments can be practiced without these details and without applying to any particular networked environment, computer architecture, system or standard.

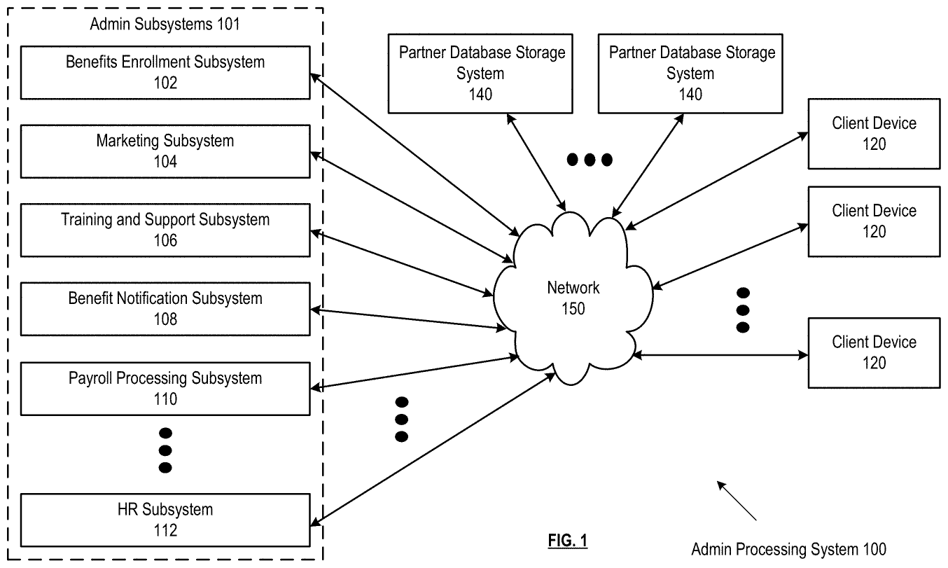

FIG. 1 presents an admin (administrative) processing system 100, which can include one or more admin subsystems 101 that communicate bidirectionally with one or more client devices 120 via a wired and/or wireless network 150. The admin subsystems 101 can include, for example, a benefits enrollment subsystem 102, a marketing subsystem 104, a training and support subsystem 106, a benefit notification subsystem 108, a payroll processing subsystem 110, HR subsystem and/or other admin subsystems for providing automated processing support to one or more partners, such as partner companies. Some or all of the subsystems 101 can utilize the same processing devices, memory devices, and/or network interfaces, for example, running on a same set of cloud servers or other shared servers connected to network 150. Alternatively, or in addition, some or all of the subsystems 101 be assigned their own processing devices, memory devices, and/or network interfaces, for example, running separately on different sets of servers connected to network 150. Some or all of the subsystems 101 can interact directly with each other, for example, where one subsystem's output is transmitted directly as input to another subsystem via network 150. Network 150 can include one or more wireless, optical and/or wired communication systems; one or more non-public intranet systems and/or public Internet systems; and/or one or more local area networks (LAN) and/or wide area networks (WAN).

The admin processing system 100 can further include one or more partner database storage systems 140 corresponding to, for example, one or more partner companies. The partner database storage systems 140 can include one or more servers, one or more memory devices of one or more subsystems 101, and/or one or more other memory devices connected to network 150. Each partner database storage system 140 can store one or more shared databases and/or one or more files stored on one or more memory devices that include records and other database entries as described herein. The shared databases and/or files can each be utilized by some or all of the subsystems of the admin processing system 100, allowing some or all of the subsystems 101 and/or client devices 120 to retrieve, review, process, edit, add, or delete entries to the one or more databases and/or files.

One or more client devices 120 can each be associated with one or more users of one or more subsystems 101 of the admin processing system 100. Some or all of the client devices 120 can be associated with insurance companies, brokers, company benefits administrators (or more simply company administrators or company admins), systems administrators, as well as human resources (HR) professionals, employees, or other individual users for example, located at a partner company or other location providing services to one or more partner companies. Some of the client devices 120 can correspond to one or more administrators of one or more subsystems of the admin processing system 100, allowing administrators and other professionals to operate, manage, supervise, or otherwise support the functions of one or more subsystems 101 for which they are authorized to access.

Some or all of the subsystems 101 of the admin processing system 100 can include a server that presents a website for operation via a browser of client devices 120. Alternatively or in addition, each client device 120 can store specific application data, a corresponding database and/or other data in a memory, data corresponding to some or all subsystems 101, for example, a subset of the subsystems 101 that are relevant to the user of the client device 120. A processor of the client device 120 can operate via a display device to display an interactive interface based on instructions in the data stored in memory and/or received via the network 150. For example, a website implemented by a subsystem 101 can operate via the application. Some or all of the websites presented can correspond to multiple subsystems 101, for example, where the multiple subsystems share the server presenting the website.

Each subsystem 101 can be configured for user authentication such as two factor authentication, password authentication or other authentication to prohibit unauthorized access. In addition, the admin subsystems 101 and partner database storage systems 140 can employ encryption, such as AES256 and/or other encryption algorithm to protect the security of data stored therein. Furthermore, the network 150 can be configured for secure communications between the admin subsystems 101, the client devices 120 and the database storage system 140 to protect the security of data communicated between the admin subsystems 101, the client devices 120 and the database storage system 140.

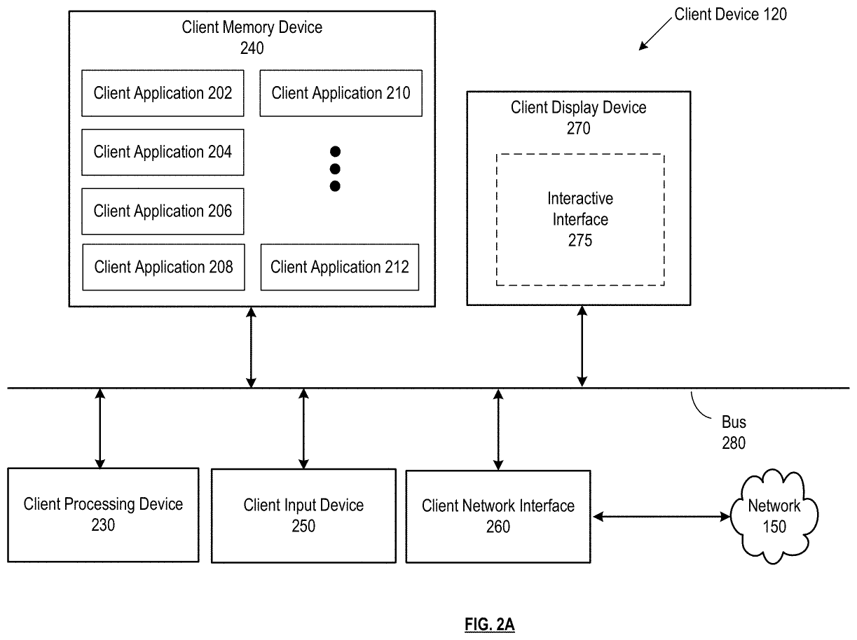

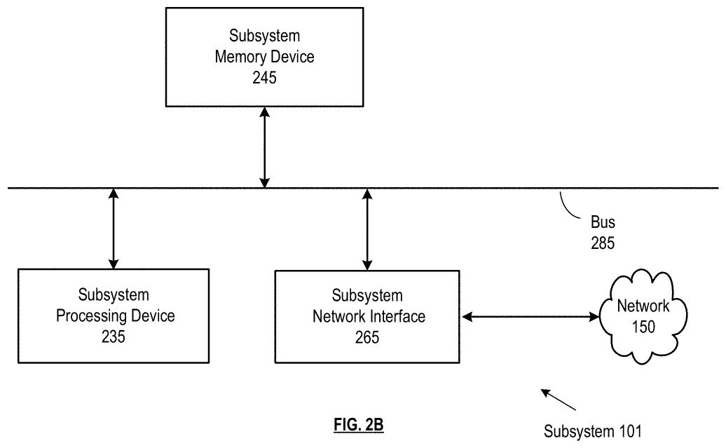

FIG. 2A presents an embodiment of client device 120. Each client device 120 can include one or more client processing devices 230 that each include a processing circuit, one or more client memory devices 240, one or more client input devices 250, one or more client network interfaces 260 operable to more support one or more communication links via the network 150 indirectly and/or directly, and/or one or more client display devices 270, connected via bus 280. While a particular bus structure is shown for purposes of illustration in a block diagram, other structures including multiple buses and/or direct connections between functional blocks. Client applications 202, 204, 206, 208, 210 and/or 212 can correspond to subsystems 102, 104, 106, 108, 110 and/or 112 of the admin processing system 100 respectfully. Each client device 120 can receive the application data from the corresponding subsystem 101 via network 150 by utilizing network interface 260, for storage in the one or more memory devices 240. In various embodiments, some or all client devices 120 can include a computing device associated with a user of one or more subsystems 101 as described herein.

In various embodiments, the memory device 240 can store executable instructions that, when executed by the processing device 230, facilitate the performance of operations by the client device 120, as discussed herein. In particular, the one or more processing devices 230 can generate an interactive interface 275 on the one or more client display devices 270 in accordance with one or more of the client applications 202, 204, 206, 208, 210, and/or 212, for example, where the same or different interactive interface 275 is displayed for some or all of the client applications in accordance with the website presented by the corresponding subsystem 102, 104, 106, 108, 110 and/or 112. The user can provide input in response to menu data, selectable links and/or other prompts presented by the interactive interface via the one or more client input devices 250, which can include a microphone, mouse, keyboard, touchscreen of display device 270 itself or other touchscreen, and/or other device allowing the user to interact with the interactive interface 275. The one or more processing devices 230 can process data and/or send raw or processed data to the corresponding subsystem 101, and/or can receive and/or generate new data in response for presentation via the interactive interface 275 accordingly, by utilizing network interface 260 to communicate bidirectionally with one or more subsystems 101, partner database storage systems 140 and/or or other systems via the network 150.

FIG. 2B presents an embodiment of a subsystem 101, which can be utilized in conjunction with subsystem 102, 104, 106, 108, 110 and/or 112. Each subsystem 101 can include one or more subsystem processing devices 235 that each include a processing circuit, one or more subsystem memory devices 245, and/or one or more subsystem network interfaces 265, connected via bus 285. While a particular bus structure is shown for purposes of illustration in a block diagram, other structures including multiple buses and/or direct connections between functional blocks. The subsystem memory devices 245 can store executable instructions that, when executed by the one or more subsystem processing devices 235, facilitate performance of operations by the subsystem 101, as described for each subsystem herein.

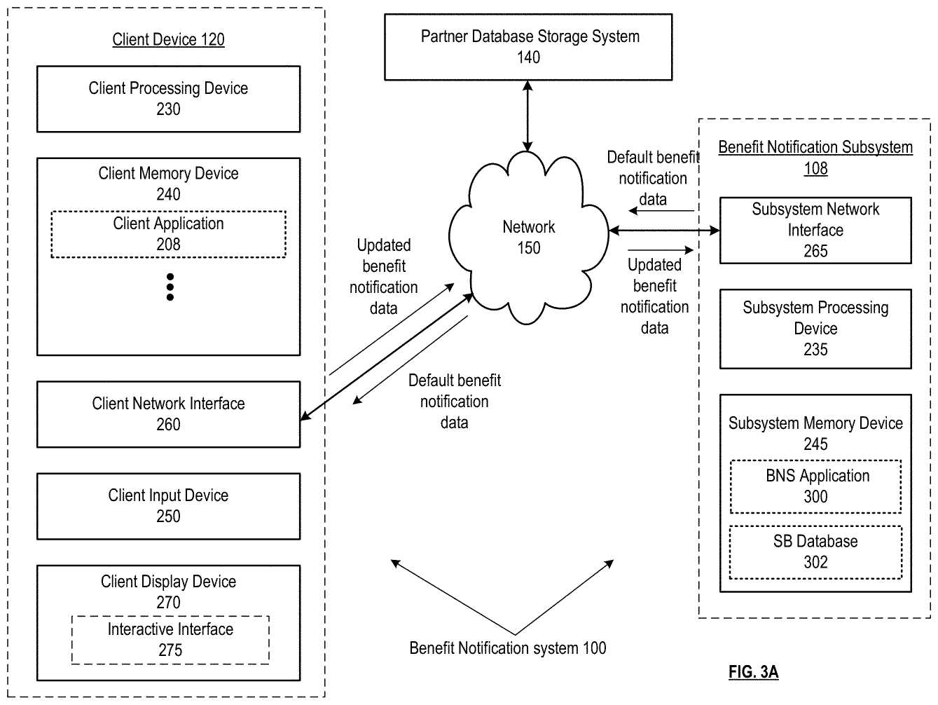

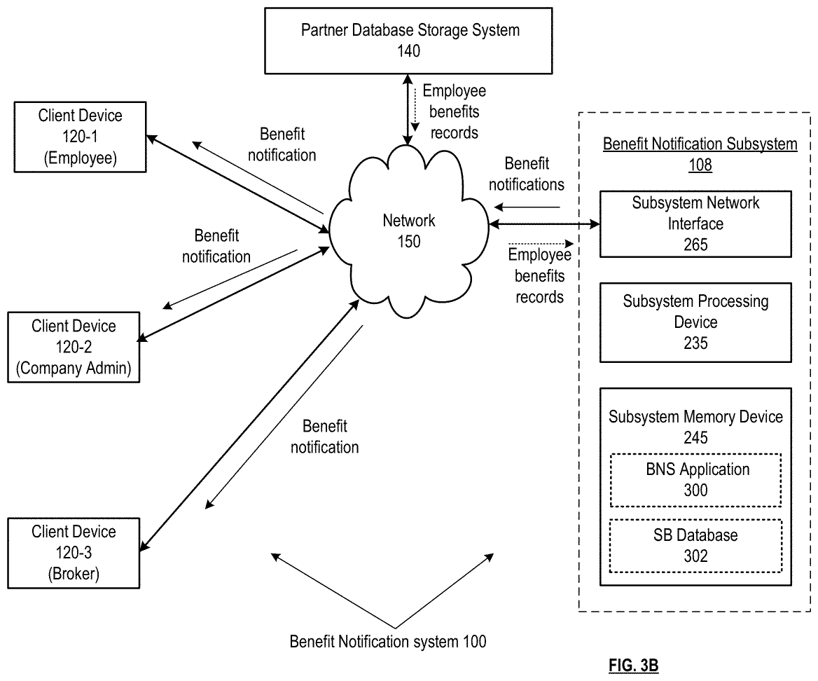

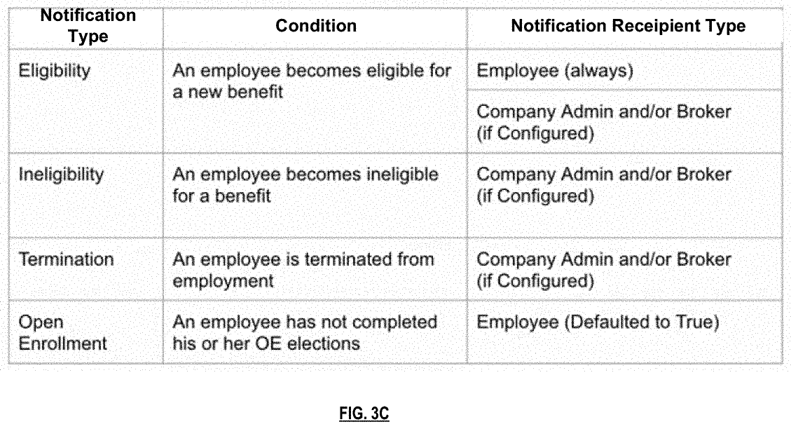

FIGS. 3A and 3B are schematic block diagrams of a benefit notification system in accordance with various embodiments. In particular, a benefit notification system 100 is presented that includes a benefit notification subsystem 108 and one or more client devices 120. The partner database storage system 140 maintains a database of partner employee benefits records for a corresponding partner/company. The subsystem memory device 245 of benefit notification subsystem 108 includes a benefit notification system (BNS) application 300 and system benefits (SB) database 302 that stores system employee benefits records corresponding, for example, to up to date system-maintained copies of the partner benefits records of partner database storage system 140 and other partner database storage systems 140 corresponding to, for example, other partners/companies. The system benefits database 302 can also store default benefit notification data and updated benefit notification data corresponding to one or more partners/companies.

The client device 120 executes the client application 208, such as a browser, operating system or other general purpose application, a database system, an email or other messaging application and/or a special purpose client application. The benefit notification subsystem 108 executes the benefit notification subsystem application 300 such as an operating system or other general purpose application along with a database system, an email or other messaging application, a special purpose server application or other application. The client application 208 and BNS application 300 of the benefit notification system 100 allow that client device(s) 120 and the benefit notification subsystem 108 to cooperate, permitting user(s) of the client device(s) 120 to perform the various functions of the benefit notification system 100 and/or to send and/or receive notifications generated by the benefit notification subsystem 108. It should be noted that this cooperation can include functions solely performed by the client device 120, functions performed solely by the and functions performed jointly via both devices. These functions include the various functions of configuring and generating benefits notifications corresponding to one or more partners whose benefits are managed by the user.

The benefit notification system 100 gives more visibility to brokers and company admins and the employees of the service on when, for example, employees actually become eligible or ineligible for benefits throughout the year. For example, eligibility notifications, such as email, text messages, automated voice messages or other notifications, are sent when an employee becomes eligible for new benefits, ineligible for existing benefits and/or is in an open enrollment period to register or change benefits.

The benefit notification system 100 improves the technology of automated benefits administration by allowing users, such as company administrators or brokers, to configure different types of notification recipients separately and independently for each of a plurality of notification types. The user interface simplifies this process and facilitates configurations to be made in a logical and efficient way. Given the graphical nature of this user interface, the technology of automated benefits administration presented by the benefit notification system 100 would be infeasible to implement within the human mind.

For example, the benefits notification functions performed by the benefit notification system 100 can include the following as shown in FIG. 3A.
Sending, from the benefit notification subsystem 108 via the network 150, default benefit notification data to the client device 120 for display via a display device, such as client display device 270.
Generating an interactive interface, such as interactive interface 275 or other graphical user interface, for display via the client display device 270. In particular, the interactive interface can be generated by the benefit notification subsystem 108 and sent as data for display via the client application 208. In the alternative, the interactive interface can be generated directly by the client application 208. The interactive interface displays the default benefit notification data corresponding to: (a) a particular company, (b) a plurality of notification types; and (c) a default subset of a plurality of notification recipient types for each of the plurality of notification types. For example, the notification types can include: an open enrollment type, a termination type, an eligibility type, an ineligibility type and/or other notification type. In various embodiments, each one of the plurality of notification types has at least one corresponding condition of a plurality of conditions that, when met, are used to trigger the generation of the associated employee benefits notification(s) to recipients of the selected recipient types. The plurality of notification recipient types can include: an employee type, a company administrator type, a broker type and/or other recipient type.
Generating, in response to a user interaction via the interactive interface, updated benefit notification data, wherein the updated benefit notification data includes a selected subset of the plurality of notification recipient types for each of the plurality of notification types. The updated benefit notification data can then be sent, via the network 150, to the benefit notification subsystem 108 for storage in the SB database 302.

For example, the benefits notification functions performed by the benefit notification system 100 can further include the following, as shown in FIG. 3B.
Obtaining employee benefit records associated with employees of the company. In particular, these employee benefit records can be obtained from the partner database storage system 140 and/or from the SB database 302.
Comparing the employee benefit records to the plurality of conditions and automatically generating at least one benefit notification for the one of the plurality of notification types when the employee benefit records compare favorable, (e.g. match) the at least one corresponding condition of the plurality of conditions. In various embodiments, the conditions can include: (a) a change from eligibility to ineligibility for one or more benefits, (b) a change from ineligibility to eligibility for one or more benefits, (c) eligibility for one or more new benefits, (d) termination of employment for the employee, and/or (e) failure of the employee to complete open enrollment procedures by a certain date, a certain period from the beginning of open enrollment, a certain time before the end of open enrollment, etc.
Facilitating transmission, based on the updated benefit notification data, of the at least one benefit notification to notification recipients corresponding to the selected subset of the plurality of notification recipient types and further corresponding to the one of the plurality of notification types. In this fashion, particular benefit notifications can be selectively and automatically sent to brokers, company admins and/or employees, via email, automated voicemail or other electronic messaging, based on the designated recipients for the particular notification type.

In various embodiments, the default benefit notification data further includes default messages for each of the plurality of notification types. In particular, the default messages can include different default messages for at least two different notification recipient types corresponding to one of the plurality of notification types. Furthermore, the updated benefit notification data can also include finalized messages for each of the plurality of notification types that are customized by the user via interaction with the interactive interface. Likewise, the finalized messages can include different finalized messages for at least two different notification recipient types corresponding to one of the plurality of notification types. Automatically generating the benefit notification(s) can be based on (e.g., can include the content of) the finalized message(s).

In various embodiments, facilitating transmission of the at least one benefit notification includes: determining messaging addresses for each of the notification recipients corresponding to the selected subset of the plurality of notification recipient types; and sending, via electronic messages to the messaging addresses, the at least one benefit notification to the each of the notification recipients corresponding to the selected subset of the plurality of notification recipient types. In various embodiments, the messaging address or addresses for each of the employees can be obtained from the partner database storage system 140 and/or from the SB database 302. Furthermore, the messaging address or addresses for the company admin(s) and broker(s) can also be stored in and obtained from the partner database storage system 140 and/or the SB database 302. In the event that there is more than one company admin and/or more than one broker associated with a particular company, the employee benefits records can indicate a single company admin and a single broker or a subset of company admins and a subset of brokers that are associated with a particular employee to facilitate the transmission of benefits notifications to the appropriate parties.

The electronic messages can be text messages, email messages, automated voice messages and/or other types of electronic messages. In particular, different messages and/or message types can be sent to at least two different notification recipient types of the plurality of notification recipient types. In particular, the updated benefit notification data can further include a selection of one of a plurality of message types for each of the plurality of recipient types. In this fashion, the types of electronic messages can, for example, be selected by the user for each notification recipient type and/or each of the notification types.

In various embodiments, the selected subset of the plurality of notification recipient types for one of the plurality of notification types includes at least one of the plurality of notification recipient types that is required to be included in the selected subset for the one of the plurality of notification types. In this fashion, while some recipient types may be optional (and selectable) for some or all of the notification types, the benefit notification system 100 may also require that notifications always be sent or never be sent to one or more of the recipient types for some or all of the notification types. Furthermore, while the selected subset of the plurality of notification recipient types for at least one of the plurality of notification types can be selected to be either a proper subset or non-proper subset, and the selected subset of the plurality of notification recipient types for one or more of the plurality of notification types can be required to be a non-null subset such as either a non-null proper subset or non-proper subset.

In various embodiments where the plurality of notification types includes an open enrollment type, a corresponding condition associated open enrollment can include an employee not yet completing open enrollment a number of days from the beginning of open enrollment. A corresponding benefits notification can include a message related to the open enrollment, when the condition is met. The updated benefits notification data can further include a selection, responsive to user interaction with the interactive interface, of the number of days from the beginning of open enrollment for this condition. The benefit notification system 100 can further operate by: comparing the selection of the number of days from the beginning of the open enrollment to the end of open enrollment; and indicating, via the interactive interface, a rejection of the selection of the number of days from the beginning of the open enrollment, when the selection of the number of days from the beginning of the open enrollment extends beyond the end of the open enrollment. Alternatively, the updated benefits notification data can further include a selection, responsive to user interaction with the interactive interface, of the number of days from the end of open enrollment for this condition. The benefit notification system 100 can further operate by: comparing the selection of the number of days from the end of the open enrollment to the beginning of open enrollment; and indicating, via the interactive interface, a rejection of the selection of the number of days from the end of the open enrollment, when the selection of the number of days from the end of the open enrollment extends beyond the beginning of the open enrollment.

Further examples including many optional functions and figures of the benefit notification system 100 are described in conjunction with the Figures that follow.

FIG. 3C presents a table of notification types, conditions and notification recipient types in accordance with various embodiments. The first row corresponds to an “eligibility” notification type that is triggered when an employee becomes eligible for a new benefit, for example, by the employee changing from part-time to full-time, a new benefit becoming available and/or other plan changes, etc. In this example, the recipient types default to the employee only, however, this can be updated to include the company administrator (admin) or the broker, via user configuration. In this fashion, the company admin and the broker recipient types are optional and selectable. Furthermore, the recipient types for eligibility notification in this example must always include the employee. In particular, the benefit notification system 100 requires that notifications always be sent to the employee for the eligibility notification type. In other words, the selected subset of notification recipient types for the eligibility notification type can be configured to be any of the following non-null proper subsets:
[employee]
[employee, company admin]
[employee, broker]
   or the non-proper subset:
[employee, broker, company admin]

The second row corresponds to an “ineligibility” notification type that is triggered when an employee becomes ineligible for a benefit, for example, when the employee is configured for full time eligibility and then transitions from full time to part time role—or some other condition by which an employee who is eligible for one or more benefits becomes ineligible for one or more of these benefits. In this example, the recipient types default to the null set, however, this can be updated to include the company administrator (admin) or the broker, via user configuration. In this fashion, the company admin and the broker recipient types are optional and selectable. In other words, the selected subset of notification recipient types for the eligibility notification type can be configured to be any of the following non-null proper subsets:
[company admin]
[broker]
[broker, company admin]

The third row corresponds to an “termination” notification type that is triggered when an employee is terminated from the company. In this example, the recipient types default to the null set, however, this can be updated to include the company administrator (admin) or the broker, via user configuration. In this fashion, the company admin and the broker recipient types are optional and selectable. In other words, the selected subset of notification recipient types for the eligibility notification type can be configured to be any of the following non-null proper subsets:
[company admin]
[broker]
[broker, company admin]

The fourth row corresponds to an “open enrollment” notification type that is triggered when an open enrollment period begins or when an employee has not completed his or her open enrollment (OE) elections by a particular date. In this example, the recipient types defaults to the employee, however, this can be updated to exclude the employee and not send notifications of this type. In other words, the selected subset of notification recipient types for the eligibility notification type can be configured to the following non-null proper subset:
[employee]
   or the null subset.

It should be noted that the notification types, and the corresponding conditions and possible notification recipient types are merely examples, and that other notification types, conditions and notification recipient types are possible. Furthermore, other combinations of conditions, default notification recipient types and selectable subsets of notification recipient types are possible for the notification types that are shown.

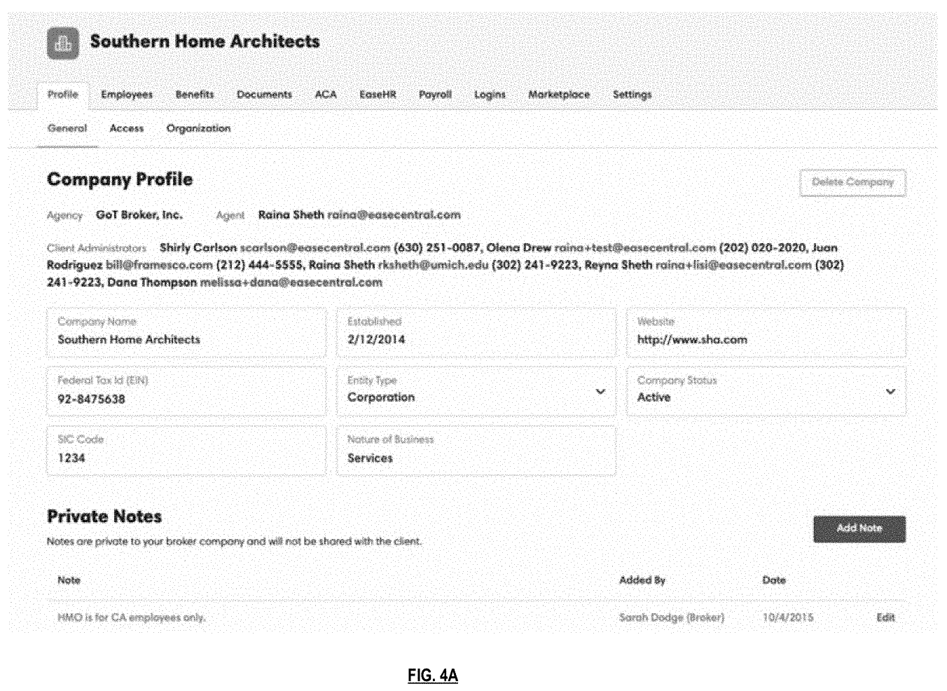

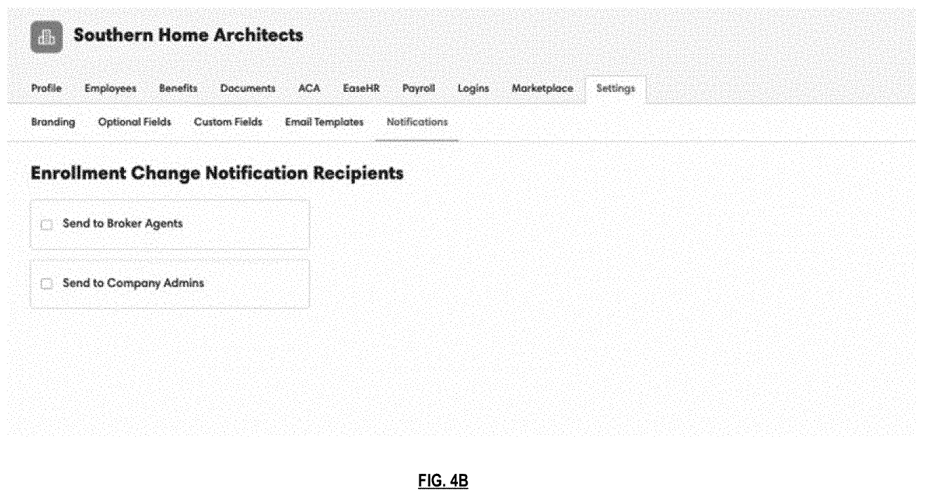

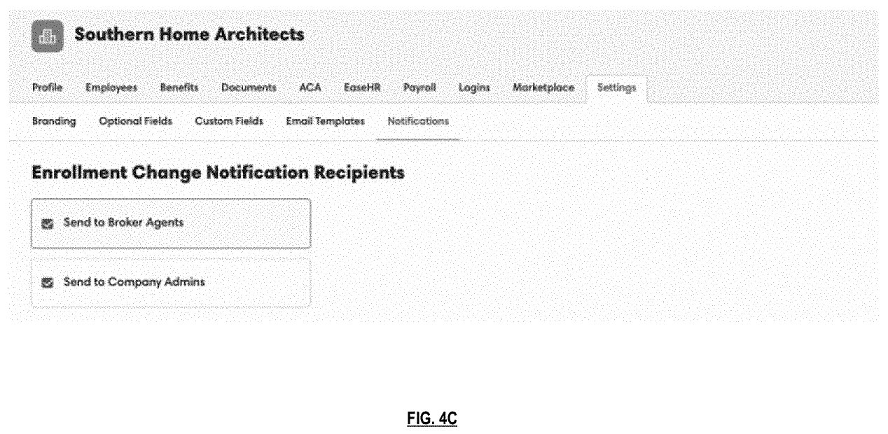

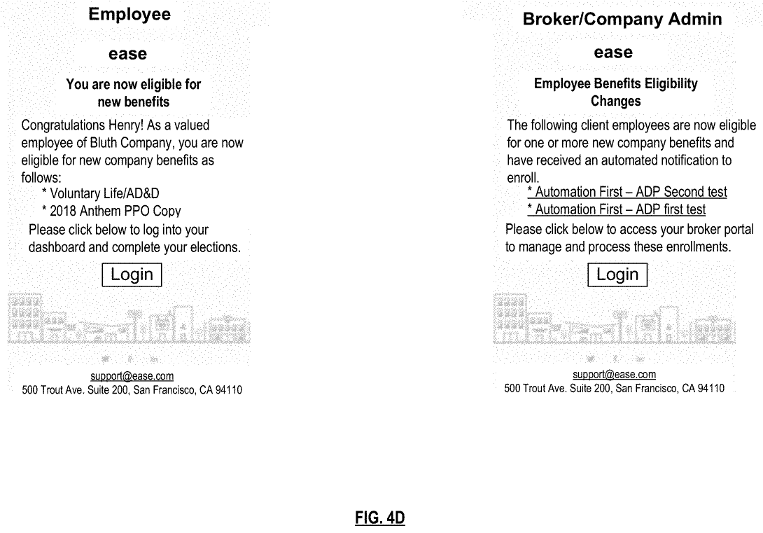

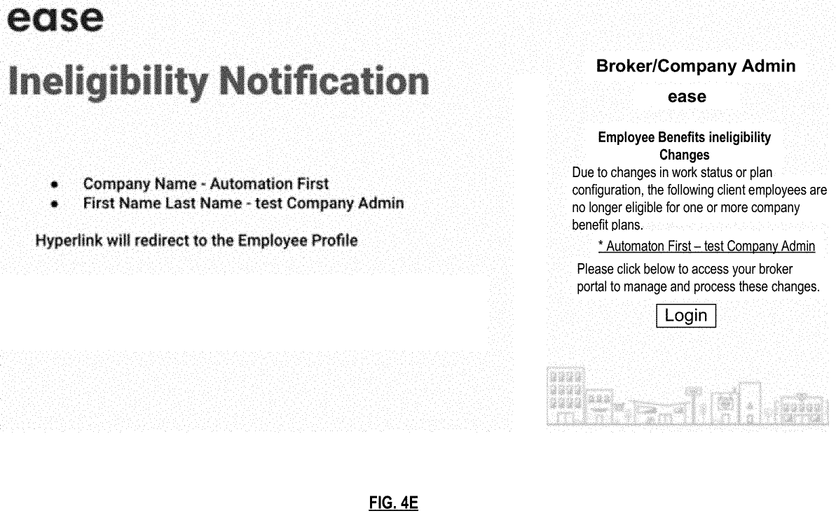

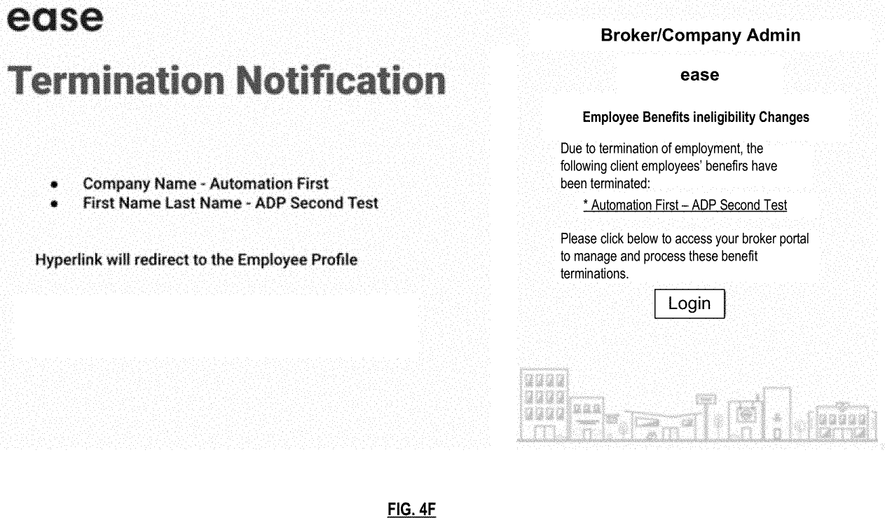

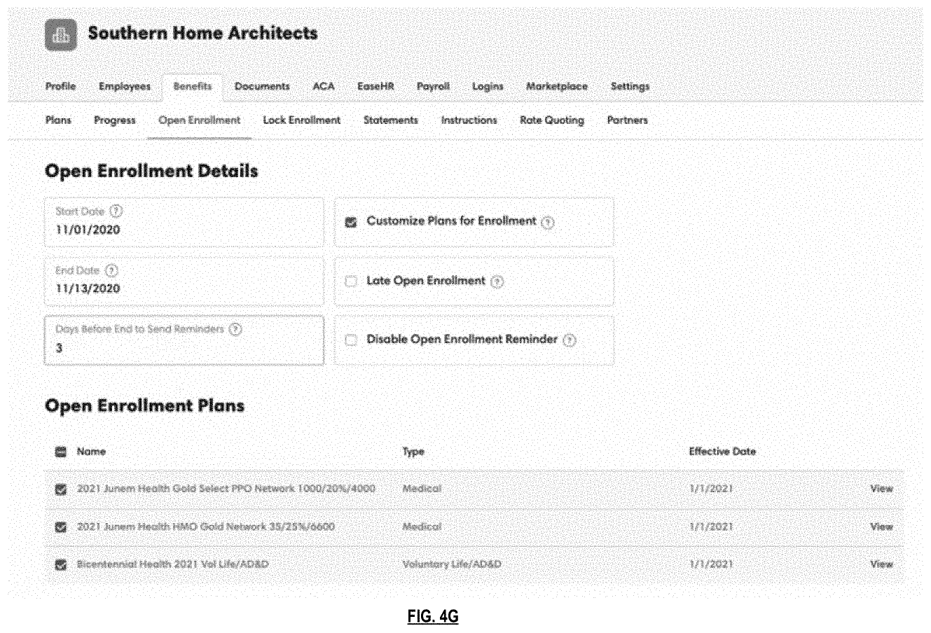

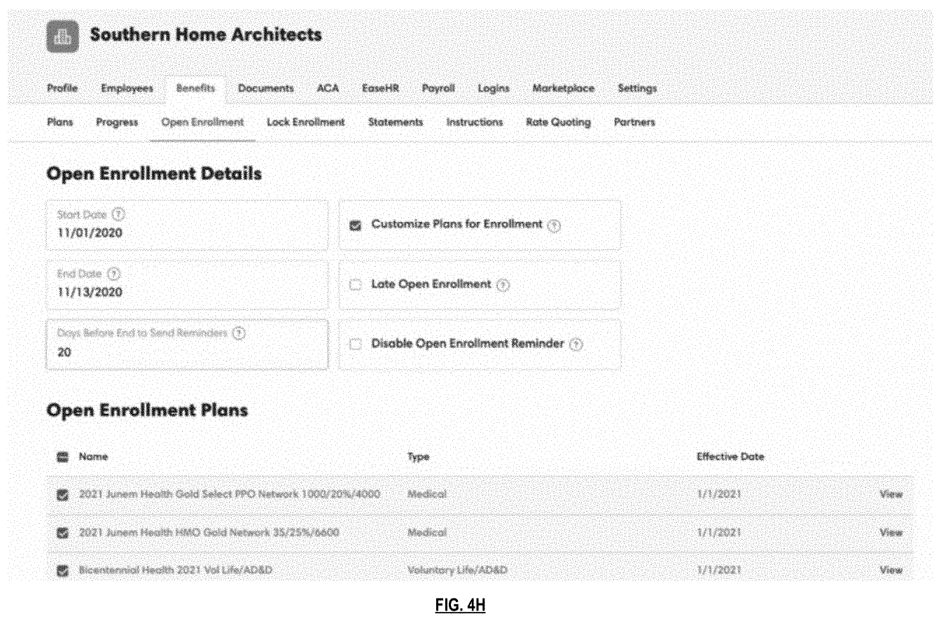

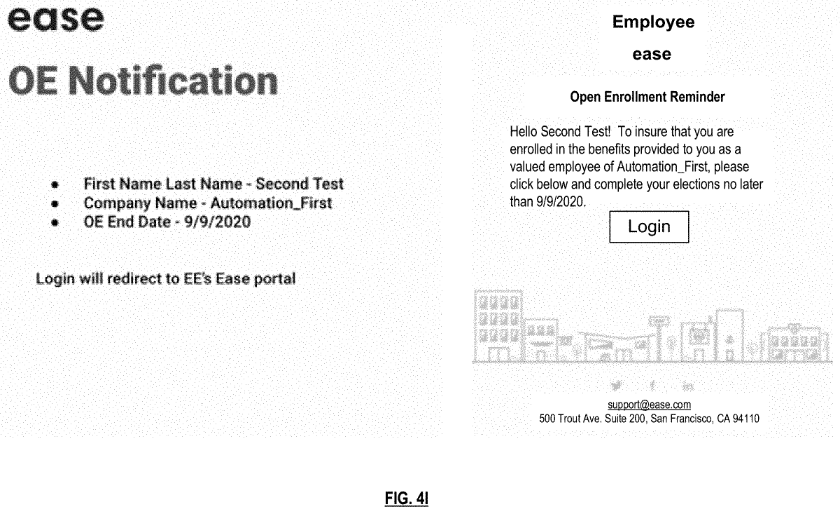

FIGS. 4A-4I are screen displays of an interactive interface in accordance with various embodiments. In particular, various screen displays are presented that are examples of displays and user interactions with interactive interface 275, generated by the benefit notification system 100, that conform with the table of FIG. 3C.

In the example shown in FIG. 4A, the benefit notification system 100 is accessed via a user in reference to a partner “Southern Home Architects” that is hypothetical and not meant to represent any actual company or entity. General company information is presented. The particular broker (agency) and broker (agent) are identified along with an email address for the particular broker. The company admins (client administrators are also identified along with their corresponding email addresses. A private notes section includes notes that are private to the broker and/or company.

In FIG. 4B, a user has elected to review the selectable notification recipient types for the eligibility notification type. As indicated, brokers and company admins are defaulted to no notification. In FIG. 4C, the user has updated the notification recipient types for the eligibility notification type to include both brokers and company admins by checking the corresponding checkboxes. While not expressly shown, the default selection of the employee recipient type can be indicated and selectable if allowed. In circumstances where the employee notification type is required as discussed in conjunction with FIG. 3C, this requirement can also be indicated—without the ability of user to change this selection/configuration.

While discussed in conjunction with eligibility notification types, similar screen display can be presented to make selections for ineligibility and termination notification types. In circumstances where the employee notification recipient type is not permitted as discussed in conjunction with FIG. 3C, this requirement can also be indicated—without the ability of user to change this selection/configuration.

In FIG. 4D, the user has elected to view sample message content for the eligibility notifications corresponding to the employee and the company admin/broker. The employee notification includes a list of the particular new benefits for which the employee is eligible. It also includes a call to action, in this example a link to a benefits portal to review these benefits and to complete the necessary benefits elections. The broker/company admin notification includes a list of the particular client employees eligible for new benefits. It also includes a call to action, in this example a link to a broker/company admin portal to manage and process these enrollments. In various embodiments, the sample message content for the eligibility notifications is selectively configurable based on user input.

In FIG. 4E, the user has elected to view sample message content for the ineligibility notifications corresponding to the company admin/broker. The broker/company admin notification includes a list of the particular client employees newly ineligible for benefits. It also includes a call to action, in this example a link to a broker/company admin portal to manage and process these changes. In various embodiments, the sample message content for the ineligibility notifications is selectively configurable based on user input.

In FIG. 4F, the user has elected to view sample message content for the termination notifications corresponding to the company admin/broker. The broker/company admin notification includes a list of the particular client employees newly terminated. It also includes a call to action, in this example a link to a broker/company admin portal to manage and process these changes. In various embodiments, the sample message content for the termination notifications is selectively configurable based on user input.

In the example shown in FIG. 4G, the benefit notification system 100 is accessed via a user in reference open enrollment details. The OE start date and end data are shown. The user can selectively customize the particular open enrollment plan, listed at the bottom of the screen. The user has the option to allow late open enrollment. In accordance with the example of FIG. 3C, the only possible notification recipient type is “employee”. The default condition is that the employee receives these notifications three days before the end of the end date of the open enrollment period. The user is given the option to disable these notifications. The user is also given the opportunity to select the number of days before the end of OE to send the OE notifications. In the example shown in FIG. 4H, the user has attempted to select the number (twenty) days before the end of OE to send the OE notifications. Because this falls before the beginning of OE, this selection is rejected as indicated by the red text and box, that for example, appears for a predetermined time period and then automatically resets to the default selection of three. It should be noted that other rejection notifications can likewise be employed.

In FIG. 4I, the user has elected to view sample message content for the OE notifications corresponding to the employee. The employee notification includes the date the OE ends. It also includes a call to action, in this example a link to a benefits portal to review these benefits and to complete the necessary benefits elections. In various embodiments, the sample message content for the OE notifications is selectively configurable based on user input.

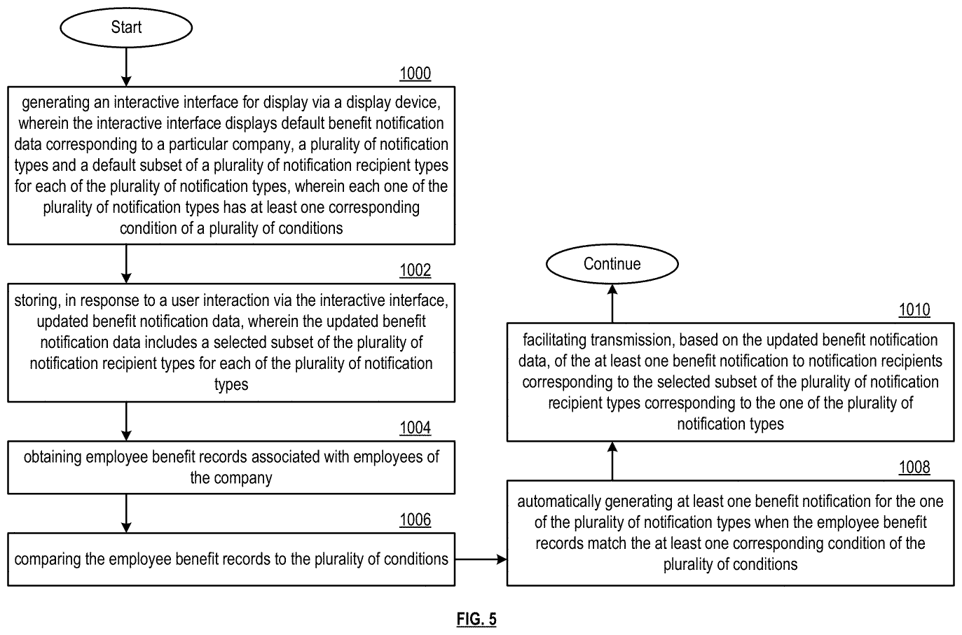

FIG. 5 is a flowchart representation of a method in accordance with various embodiments. In particular, a method is presented for use in conjunction with one or more functions and features previously described. Step 1000 includes generating an interactive interface for display via a display device, wherein the interactive interface displays default benefit notification data corresponding to a particular company, a plurality of notification types and a default subset of a plurality of notification recipient types for each of the plurality of notification types, wherein each one of the plurality of notification types has at least one corresponding condition of a plurality of conditions. Step 1002 includes storing, in response to a user interaction via the interactive interface, updated benefit notification data, wherein the updated benefit notification data includes a selected subset of the plurality of notification recipient types for each of the plurality of notification types. Step 1004 includes obtaining employee benefit records associated with employees of the company. Step 1006 includes comparing the employee benefit records to the plurality of conditions. Step 1008 includes automatically generating at least one benefit notification for the one of the plurality of notification types when the employee benefit records match the at least one corresponding condition of the plurality of conditions. Step 1010 includes facilitating transmission, based on the updated benefit notification data, of the at least one benefit notification to notification recipients corresponding to the selected subset of the plurality of notification recipient types corresponding to the one of the plurality of notification types.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A benefit notification system, comprising:
at least one processing system that includes a processor; and
at least one memory including a non-transitory computer readable storage medium that stores executable instructions that, when executed by the at least one processing system, facilitate performance of operations that include:
generating an interactive interface for display via a display device, wherein the interactive interface displays default benefit notification data corresponding to a particular company, a plurality of notification types and a default subset of a plurality of notification recipient types for each of the plurality of notification types, wherein each one of the plurality of notification types has at least one corresponding condition of a plurality of conditions;
storing, in response to a user interaction via the interactive interface, updated benefit notification data, wherein the updated benefit notification data includes a selected subset of the plurality of notification recipient types for each of the plurality of notification types;
obtaining employee benefit records associated with employees of the company;
comparing the employee benefit records to the plurality of conditions;
automatically generating at least one benefit notification for the one of the plurality of notification types when the employee benefit records match the at least one corresponding condition of the plurality of conditions; and
facilitating transmission, based on the updated benefit notification data, of the at least one benefit notification to notification recipients corresponding to the selected subset of the plurality of notification recipient types corresponding to the one of the plurality of notification types.

2. The benefit notification system of claim 1, wherein the plurality of notification types include at least one of: an open enrollment type, a termination type, an eligibility type or a ineligibility type.

3. The benefit notification system of claim 1, wherein the plurality of notification recipient types include at least one of: an employee type, a company administrator type or a broker type.

4. The benefit notification system of claim 1, wherein the default benefit notification data further includes default messages for each of the plurality of notification types.

5. The benefit notification system of claim 4, wherein the default messages include different default messages for at least two different notification recipient types corresponding to one of the plurality of notification types.

6. The benefit notification system of claim 4, wherein the updated benefit notification data further includes finalized messages for each of the plurality of notification types.

7. The benefit notification system of claim 6, wherein the finalized messages include different finalized messages for at least two different notification recipient types corresponding to one of the plurality of notification types.

8. The benefit notification system of claim 6, wherein automatically generating the at least one benefit notification for the one of the plurality of notification types, is based on a corresponding at least one of the finalized messages.

9. The benefit notification system of claim 1, wherein facilitating transmission of the at least one benefit notification includes:
determining messaging addresses for each of the notification recipients corresponding to the selected subset of the plurality of notification recipient types; and
sending, via electronic messages to the messaging addresses, the at least one benefit notification to the each of the notification recipients corresponding to the selected subset of the plurality of notification recipient types.

10. The benefit notification system of claim 9, wherein the electronic messages include different messages sent to at least two different notification recipient types of the plurality of notification recipient types.

11. The benefit notification system of claim 9, wherein the electronic messages include at least one of: a text message and/or an email message.

12. The benefit notification system of claim 9, wherein the updated benefit notification data further includes a selection of one of a plurality of message types for each of the plurality of recipient types.

13. The benefit notification system of claim 1, wherein the selected subset of the plurality of notification recipient types for one of the plurality of notification types includes at least one of the plurality of notification recipient types that is required to be included in the selected subset for the one of the plurality of notification types.

14. The benefit notification system of claim 1, wherein the selected subset of the plurality of notification recipient types for each of the plurality of notification types is required to be a non-null subset.

15. The benefit notification system of claim 1, wherein the selected subset of the plurality of notification recipient types for at least one of the plurality of notification types is selected to be either a proper subset or not a proper subset, responsive to the user interaction via the interactive interface.

16. The benefit notification system of claim 1, wherein the plurality of notification types includes an open enrollment type, wherein the at least one corresponding condition of the plurality of conditions includes an open enrollment condition associated with an employee not completing open enrollment by a number of days from a beginning of the open enrollment.

17. The benefit notification system of claim 16, wherein the at least one benefits notification includes a message related to the open enrollment when the open enrollment condition is met, wherein the message prompts the employee to complete open enrollment.

18. The benefit notification system of claim 16, wherein the updated benefits notification data further includes a selection of the number of days from the beginning of the open enrollment, and wherein the operations further include:
comparing the selection of the number of days from the beginning of the open enrollment to an ending of the open enrollment; and
indicating, via the interactive interface, a rejection of the selection of the number of days from the beginning of the open enrollment, when the selection of the number of days from the beginning of the open enrollment extend beyond the ending of the open enrollment.

19. The benefit notification system of claim 1, wherein the plurality of notification types includes an open enrollment type, wherein the at least one corresponding condition of the plurality of conditions includes an open enrollment condition associated with an employee not completing open enrollment by a number of days from an end of the open enrollment, wherein the at least one benefits notification includes a message related to the open enrollment when the open enrollment condition is met, wherein the message prompts the employee to complete open enrollment, and wherein the updated benefits notification data further includes a selection of the number of days before the end of the open enrollment, and wherein the operations further include:
comparing the selection of the number of days before the end of the open enrollment to a beginning of the open enrollment; and
indicating, via the interactive interface, a rejection of the selection of the number of days before the end of the open enrollment, when the selection of the number of days before the end of the open enrollment extends beyond the beginning of the open enrollment.

20. A method for use with a benefit notification system that includes at least one processing system that includes a processor and at least one non-transitory computer readable storage medium that stores executable instructions that, when executed by the at least one processing system, facilitate performance of operations, the method comprising:
generating an interactive interface for display via a display device, wherein the interactive interface displays default benefit notification data corresponding to a particular company, a plurality of notification types and a default subset of a plurality of notification recipient types for each of the plurality of notification types, wherein each one of the plurality of notification types has at least one corresponding condition of a plurality of conditions;
storing, in response to a user interaction via the interactive interface, updated benefit notification data, wherein the updated benefit notification data includes a selected subset of the plurality of notification recipient types for each of the plurality of notification types;
obtaining employee benefit records associated with employees of the company;
comparing the employee benefit records to the plurality of conditions;
automatically generating at least one benefit notification for the one of the plurality of notification types when the employee benefit records match the at least one corresponding condition of the plurality of conditions; and
facilitating transmission, based on the updated benefit notification data, of the at least one benefit notification to notification recipients corresponding to the selected subset of the plurality of notification recipient types corresponding to the one of the plurality of notification types.
